(19) United States
(12) Patent Application Publication
(10) Pub. No.: US 2004/0224179 A1
(43) Pub. Date: Nov. 11, 2004

(54) Laser peening method and apparatus using tailored laser beam spot sizes

(75) Inventors: David W. Sokol, Dublin, OH (US); Allan H. Clauer, Worthington, OH (US)

Correspondence Address: RANDALL J. KNUTH P.C., 3510-A STELLHORN ROAD, FORT WAYNE, IN, 46815-4631, US

(73) Assignee: LSP Technologies, Inc.

(21) Appl. No.: 10/434,621

(22) Filed: May 9, 2003

(51) Int. Cl. B23K 26/00; B32B 7/10

(52) U.S. Cl. 428/610; 219/121.85

(57) ABSTRACT

A laser shock processing treatment enables a selectively adjustable and customized compressive residual stress distribution profile to be developed within a workpiece by tailoring the size and shape of the laser beam spots. One peening operation applies to the workpiece a first pattern having relatively large laser beam spots and then applies a second pattern having relatively small laser beam spots. The composite use of such small and large beam spots enables the stress distribution profile to be tailored to the part specifications. The large beam spots maximize the depth of compressive residual stress in the part, while the small beam spots optimize the surface compressive residual stresses of the part. The use of small spot beam patterns allows untreated or improperly processed areas to be laser peened.

### BACKGROUND OF THE INVENTION

1. Field of the Invention

The present invention relates to a laser shock processing treatment, and, more particularly, to a method, system, and article utilizing various configurations of laser beam spot patterns having spot sizes that are tailored to achieve desired compressive residual stress distribution profiles in a part, such as a stress response having specific stress components and/or characteristics at certain surface and subsurface locations of the part.

2. Description of the Related Art

Laser peening operations provide a treatment procedure that increases the fatigue and corrosion resistance of parts (e.g., metal) by introducing compressive residual stresses through the surface of the part. This stress treatment typically is accomplished by peening the part with a laser pulse having a diameter of approximately 5 mm on the surface of the part, a width of 20 ns, and energy of 40-50 Joules. The treatment enables compressive stresses to reach a penetration depth of greater than 1 mm, but does not necessarily produce optimal surface stresses when treating part geometries having a thin section thickness.

Optimal surface stresses may be introduced by shortening the pulse width of the laser emission. For example, compression stress profiles which do not extend much below the surface, but have optimal surface stresses may be formed by using a laser pulse having a temporal width of approximately 7 ns, a diameter of approximately 5 mm on the surface of the part, and energy of 10-15 Joules. However, such modification of the pulse width is not easily achieved. In particular, the short pulse width is difficult to achieve with a common Nd:glass laser and typically is relatively unstable.

What is therefore needed is a more reliable method for adjusting the compressive residual stress distribution profile induced by laser peening.

### SUMMARY OF THE INVENTION

According to the present invention there is provided a method, system, and article for creating a selectively customized compressive residual stress distribution profile in a workpiece by laser shock peening. The invention employs the use of variably sized laser beam spots to generate corresponding, spot-size-dependent stress features in the workpiece.

In particular, the invention takes advantage of the phenomenon that relatively large laser beam spots produce relatively deeper compressive residual stresses, while relatively small laser beam spots produce relatively shallower compressive residual stresses. For example, a suitable combination of large and small laser beam spots may be chosen to maximize the in-depth compressive residual stress distribution profile, while optimizing the surface stresses, or a pattern consisting of only one selected optimal spot size may be applied. Generally, the overall composite stress distribution profile formed by laser peening can be tailored to the part requirements and specifications by adjustably selecting the spot sizes and beam patterns so as to match the desired resultant stress profile.

One advantage of the present invention is that adjustment of the pulse width as a factor in customizing the stress profile can be avoided since a relatively longer pulse width can be used with the variably sized laser beam spots.

Another advantage of the present invention is that a peening operation can be developed that optimizes both the surface and in-depth compressive residual stresses with a suitable combination of large and small laser beam spots.

A further advantage of the invention is that a wide range of stress distribution profiles can be formed by using the appropriate combination of variably-sized laser beam spots that compositely produce the desired profile or by using an optimal spot size that produces the desired profiles.

Another advantage of the invention is that relatively small laser beam spots can be used as stress bridges between gaps in a large-spot peening pattern.

Another advantage of the invention is that relatively small laser beam spots can be used to apply original or repeated laser shock processing to designated areas of a workpiece.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a flowchart depicting an illustrative laser shock processing procedure for treating a workpiece, according to the present invention;

FIG. 2 is a flowchart depicting an illustrative subroutine for use in the procedure of FIG. 1 to develop a set of laser beam spot patterns having variably-sized laser beam spots, according to the present invention;

FIG. 3 is a graphical illustration of one representative set of individual and composite stress response curves that may be formed in a workpiece, in accordance with the invention;

FIGS. 4A-G schematically depict various illustrative laser beam spot configurations, according to the present invention;

FIG. 5 is a schematic sectional view of a workpiece portion illustrating the manner in which laser beam spots having different spot sizes are applied during laser shock peening, according to the invention;

FIG. 6 is a schematic cross-sectional fragmentary view of a workpiece illustrating a dual-sided laser shock peening treatment, according to the invention;

FIG. 7 is a flowchart depicting an illustrative laser shock processing procedure for treating a workpiece, according to the present invention;

FIG. 8 is a schematic view of one illustrative topology of laser beam spots for peening a workpiece, according to the processing procedure set forth in FIG. 7;

FIG. 9 is a schematic diagram of a laser shock peening apparatus for use in practicing the present invention;

FIG. 10 is a schematic perspective view of an engine blade capable of being processed and produced by the present invention;

FIG. 11 is a cross-sectional schematic view of the airfoil portion of the engine blade shown in FIG. 10, taken along lines 15-15; and

FIG. 12 is a block diagram representation of a laser shock processing system configured to practice the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

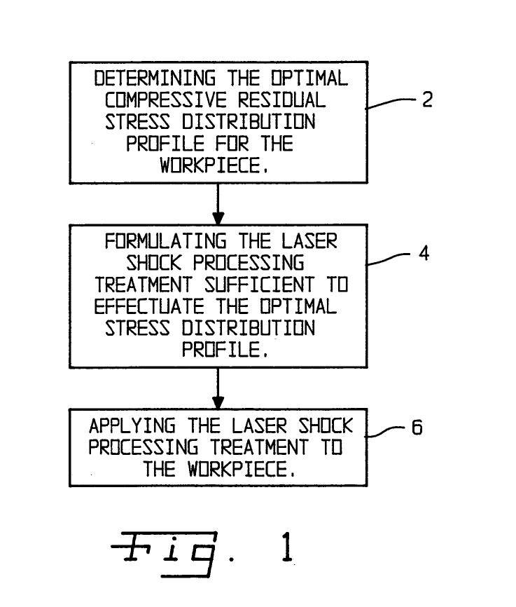

Referring now to the drawings and particularly to FIG. 1, there is shown a flowchart generally illustrating a laser shock processing procedure for treating a workpiece, according to one example of the present invention.

By way of overview, current manufacturing practices have generally not succeeded in adequately addressing the need to develop in-line or post-production treatments that foster the formation of desired stress fields in a part or workpiece under consideration. Parts such as turbine engine blades that experience significant operational forces are susceptible to high-cycle fatigue and potentially irreversible failure. Accordingly, it is important to create stress gradients in the part to counteract the expected service torque and force stresses.

These high-cycle fatigue-susceptible parts also are typically installed in high-pressure and high-temperature conditions that can make the parts even more vulnerable to the formation of incipient weaknesses. Flaws and other design defects may also contribute to the overall diminished integrity of the part. It is therefore important to formulate a treatment or processing protocol that improves and strengthens the integrity of the production workpieces. Any such treatment should be able to develop a customized stress distribution field that is tailored to the requirements of the part and optimally maximizes the stress gradients in certain specified locations, such as where weakness or flaws may exist or where the part encounters significant operational loading. The determination of the most beneficial magnitude and location of the residual stresses in the customized stress distribution field can be determined by various means known to those skilled in the art, such as finite element and other models, failure models and experience.

In addressing this need, the invention proposes to provide a laser shock processing treatment that enables a designer to implement a variably customized and location-selectable stress distribution profile throughout a workpiece. The invention recognizes that an important relationship exists between the laser beam spot sizes used in a laser shock processing treatment and the type of compressive residual stress distribution profile that is formed as a result of the laser peening.

In particular, the invention recognizes that different laser beam spot sizes produce correspondingly different penetration depths for the compressive residual stresses induced by laser peening. This phenomenon allows a designer to institute a set of generally uniform laser peening parameters while varying the laser beam spot sizes to implement the desired stress gradients. Thus, adjustment of the depth of the compressive residual stresses produced during laser peening can be implemented simply by making selective variations to the spot size.

This uniformity in peening parameters (other than the spot size) is particularly advantageous since a relatively constant and stable pulse width can be used across all laser beam spot sizes. In particular, approximately the same pulse width can be used for differing spot sizes. Since adjustments to the spot size and not the pulse width remain the basis for tailoring the stress distribution profile, the designer is free to select a pulse width that can be readily accommodated by the peening equipment. For example, a relatively longer pulse width is typically considered a more stable signal compared to a shorter pulse width. Accordingly, the designer is generally relieved of any considerations pertaining to the temporal characteristics of the laser beam output.

According to another aspect of the invention, there is provided a facility that correlates laser peening beam spot size with a characteristic compressive residual stress distribution profile or response present within the treated workpiece. Such correlation data can be obtained by any means known to those skilled in the art, for example, empirical evaluation, computer modeling, or finite element analysis. The variable relationship between the laser beam spot sizes used in a laser shock processing treatment and the stress response enable a designer to formulate a set of variably-sized laser beam spot patterns in accordance with the final stress response desired in the workpiece. The effective or resultant overall stress profile will be achieved by the combination and/or composite total correlating to the individual stress responses associated with each laser peening beam pattern.

In general, with all other factors generally the same, the penetration depth of a compressive residual stress distribution profile imparted by laser shock peening varies generally in direct relationship to the laser beam spot size below spot size of nominally 1 mm. Thus, a relatively smaller spot size will produce a maximal stress response characteristic that is shallower (i.e., remains closer to the laser shock peened surface) than a relatively larger spot size, which produces a maximal stress response characteristic that is comparably deeper (i.e., extends further away from the laser shock peened surface).

One specific aspect of the invention is directed to the use of variably-sized laser spots to achieve optimally maximum compressive residual stresses at a surface or near-surface region and optimally maximum compressive residual stresses at a subsurface (i.e., relatively deep) interior region. In one simple form, this type of laser peening treatment would use a laser beam pattern with relatively large beam spots to effectuate a relatively deep stress response, and another laser beam pattern with relatively small beam spots to effectuate a relatively shallow stress response where the largest stress gradients are located at or near the surface.

For example, referring to FIG. 3, there is shown an illustrative stress distribution profile which graphically depicts the individual and composite stress responses that follow from the use of variably-sized laser beam spots in a laser peening operation. The stress responses are expressed or defined in terms of compressive residual stress (y-axis) as a function of penetration depth (x-axis). In particular, curve 20 represents a characteristic stress response due to a relatively small spot size, while curve 22 represents a characteristic stress response due to a relatively large spot size.

As shown, response 20 includes a maximal stress component portion (generally indicated at 26) that is located at or near the workpiece surface (i.e., approximately zero depth) and a compressive stress extending only a short distance below the surface. By comparison, response 22 includes a maximal stress component portion (generally indicated at 24) that may be located at the surface or at a relatively deeper location within the workpiece, and the compressive stress extends much deeper below the surface. The composite stress response curve resulting from the combination of stress responses 20 and 22 is indicated by curve 28 (dashed line). As shown, the effective total response includes both the surface and subsurface stress response components contributed respectively by small-spot curve 20 and large-spot curve 22. In this manner, it is seen that the resultant compressive residual stress distribution profile can be tailored to the requirements of the part by appropriately specifying the laser beam spot sizes used during laser peening.

Referring back to FIG. 1, the general methodology of the present invention illustratively includes a subroutine or subprocedure that determines the optimal compressive residual stress distribution profile for the workpiece. (Step 2). Any means known to those skilled in the art may be used for this purpose. This determination will typically take into account, for example, any known areas of weakness in the workpiece, flaws, sites of high operational cyclic or static forces and/or pressures, and any other factors useful in maintaining and promoting the integrity of the part.

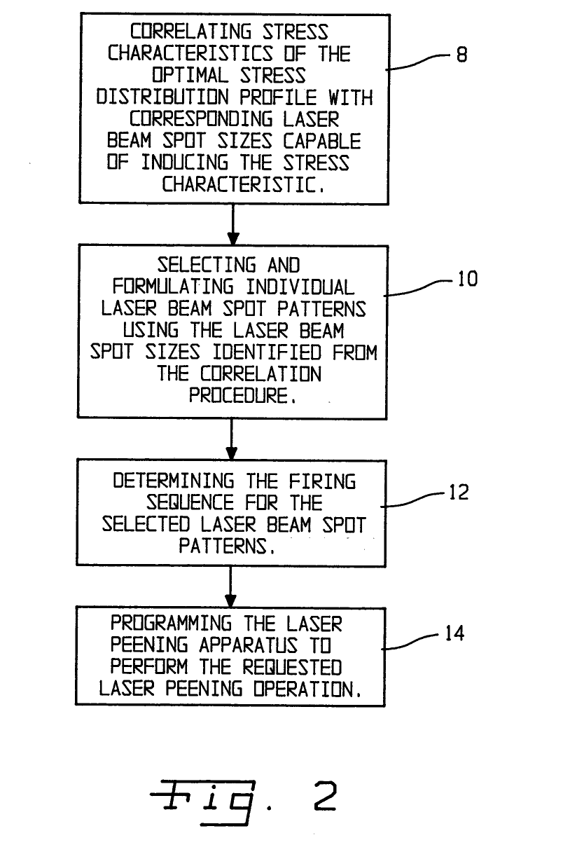

Based upon this determination of the optimal stress profile, a suitable laser shock processing treatment is formulated that is capable of implementing, effectuating, or otherwise enabling the optimal stress distribution profile. (Step 4). Details of this treatment formulation step are provided in FIG. 2, according to another example of the present invention. Following formulation of the laser shock processing treatment, the workpiece is subsequently processed by applying the treatment to the workpiece. (Step 6).

Referring to FIG. 2, there is shown a flowchart illustratively depicting a general methodology for implementing Step 4 of the flowchart of FIG. 1, namely, the step of formulating a laser shock processing treatment that is sufficient to produce the desired stress distribution profile in the workpiece, according to another example of the invention.

According to one aspect of the invention, the desired or target optimal composite stress distribution profile is examined to determine its principal gradient or stress contour features and/or characteristics. For example, referring to FIG. 3, an analysis of curve 28 as the optimal stress distribution profile would yield data indicating surface stress components 24 and 26, (associated respectively with large and small spot laser peening) and in-depth stress component 22 and 20, respectively.

This optimal stress response data would then be evaluated in light of laser beam spot information that represents data indicating the correlative or associative relationship between laser beam spot size and characteristic stress response. Any means may be used to collect, obtain, compile, or produce such information. The laser beam spot information will typically be furnished across all types of peening conditions, such as power output levels, pulse width, and other operating parameters.

The evaluation aims to identify the set of individual characteristic stress response curves that in composite will produce an effective or total stress distribution profile having a best-fit match with the desired optimal stress response. Accordingly, the evaluation task will correlate or associate the various stress characteristics, components, or features of the optimal stress distribution profile with a corresponding set of laser beam spot sizes that are capable of inducing the respective stress features. (Step 8).

Next, the selected laser beam spot sizes are employed as part of a procedure to develop the appropriate set of laser beam spot patterns that will be applied to the workpiece. (Step 10). The formulation of such beam patterns employs conventional techniques well known to those skilled in the art. Additionally, the firing order is selected for the purposes of determining when and in what sequence the laser beam spot patterns will be applied to the workpiece. (Step 12). Other operational parameters appropriate to the laser peening activity are also selected.

In one form, for example, the controller for the laser peening apparatus is programmed with the operating information so that the requested laser peening operation can be performed automatically under the control of a computer module. (Step 14). Conventional programming techniques may be used for this purpose.

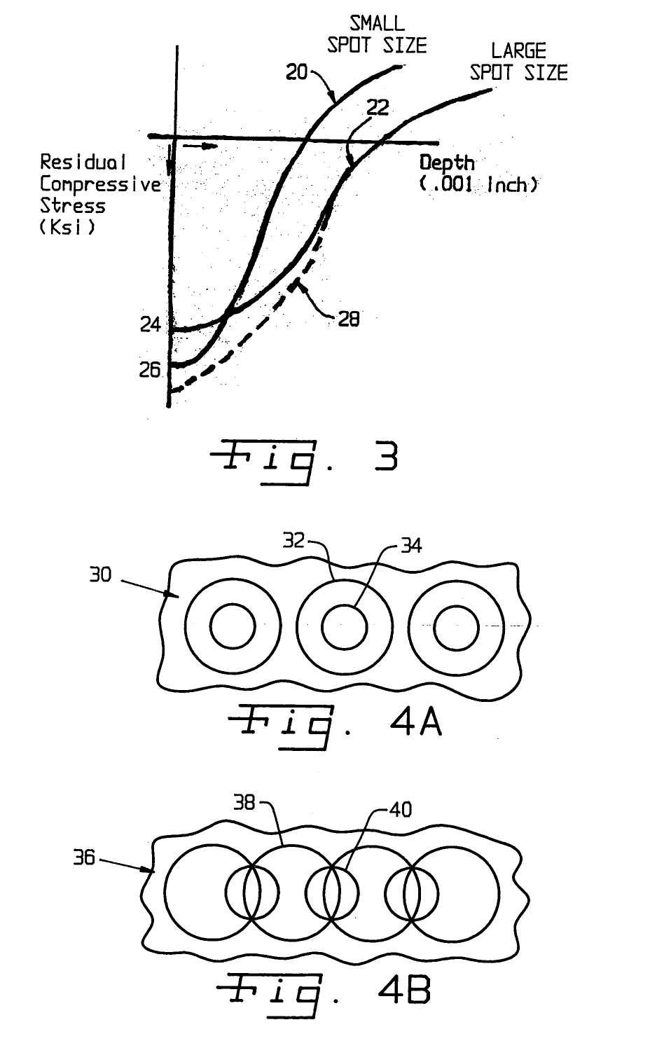

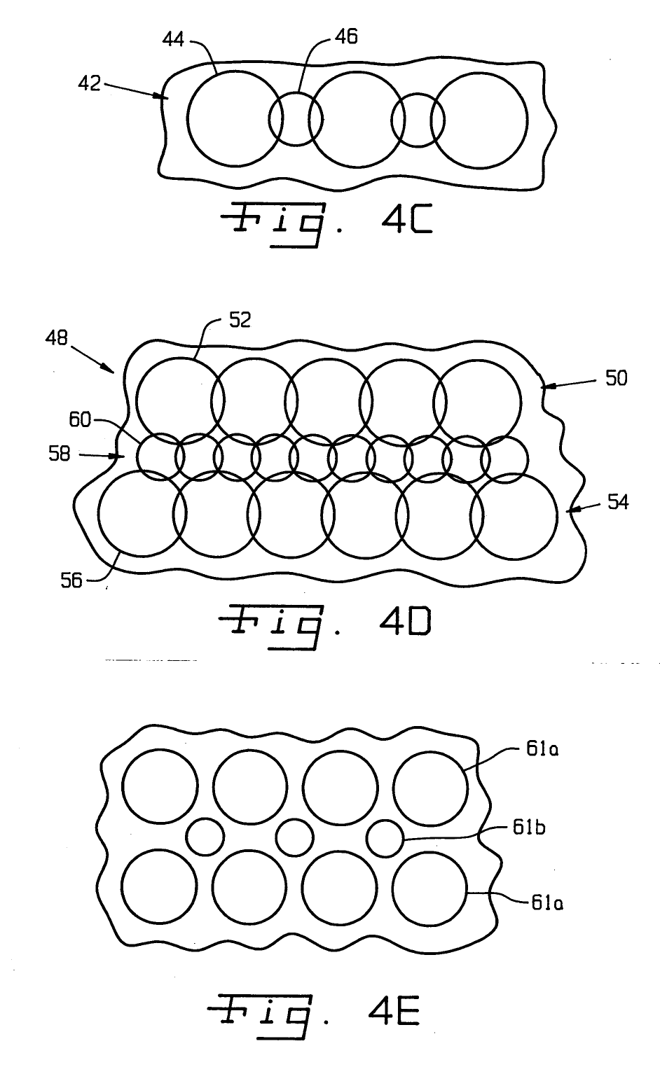

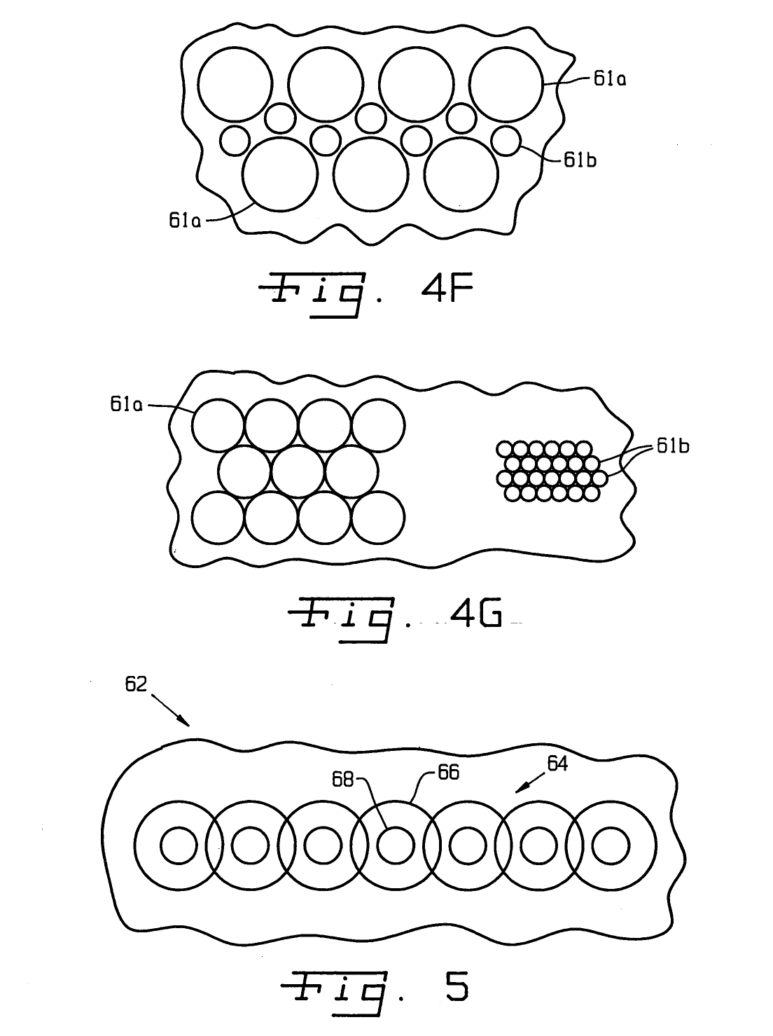

Referring now to FIG. 4, there is shown a series of schematic diagrams illustrating various applications of the methodology described in FIGS. 1 and 2, according to another example of the present invention. In particular, various laser beam spot configurations are shown which depict illustrative types of large spot and small spot combinations that serve certain purposes and provide certain advantages.

The indicated configurations are shown for illustrative purposes only and should not be considered in limitation of the present invention, as it should be apparent that any other and different configuration, arrangement, orientation, and placement of variably-sized laser beam spots may be employed.

Additionally, although the spot geometries described herein employ a circular formation, this feature should not be considered in limitation of the present invention. Rather, it should be apparent that any laser beam spot shape or geometry may be used in practicing the invention. Moreover, it should be apparent that the illustrated beam spot arrangements are partial representations of a fuller and more comprehensive pattern that can be applied to any selected portion of the workpiece, such as a leading or trailing edge of a part, a specified coverage area, or the entire part surface.

Furthermore, although the beam spot patterns described herein employ a linear row-column grid or matrix arrangement, it should be apparent that any type of pattern configuration may be used. Additionally, adjacent rows may be aligned or offset from one another or utilize any other type of spacing and/or relative orientation.

Referring to FIG. 4A, there is shown a laser beam spot configuration 30 including a row-like set of relatively large beam spots 32 and a row-like set of relatively small beam spots 34 each disposed at an interior of a respective large beam spot 32. In one form, the large beam spots 32 would be applied to the workpiece as part of one pattern arrangement, while small beam spots 34 would be similarly applied to the workpiece as part of another pattern arrangement.

Although the large beam spots 32 are spaced-apart from one another, any other conventional arrangement may be employed as known to those skilled in the art, such as an overlapping relationship with adjacent beam spots. Additionally, it would typically be the case that the large beam spots 32 would be applied first and then followed with the small beam spots 34, although a different order may also be used.

Referring to FIG. 4B, there is shown a laser beam spot configuration 36 including a row-like set of relatively large beam spots 38 disposed in adjacent overlapping relationship with one another. There is also provided a row-like set of relatively small beam spots 40 that encompass (at least in part) the region of overlap between adjacent overlapping large beam spots 38.

In this manner, the small beam spots 40 address situations in which the production cycle produces a large beam spot pattern having insufficient overlap between adjacent laser beam spots 38 or in which it is desirable to enhance the overlap effect. According to the invention, the small beam spots 40 can be applied to the workpiece to cover the existing overlap and the surrounding neighborhood, in such a manner as to encompass and/or circumscribe the intended overlap area. Alternatively, the spots could be placed in the centers of the large spots, between the overlap areas to provide greater process uniformity to the processed area.

Referring to FIG. 4C, there is shown a laser beam spot configuration 42 including a row-like set of relatively large beam spots 44 disposed in spaced-apart relationship to one another. The spacing between adjacent large beam spots 44 can occur in any manner, such as by a purposeful design selection or by inadvertence, e.g., a mistake in applying or forming the beam pattern. Regardless of the cause, the gap between adjacent large beam spots 44 can be covered or “filled-in” using a row-like set of relatively small intervening beam spots 46 that are disposed between adjacent large beam spots 44. In particular, small beam spots 46 encompass the gap and preferably overlap (at least in part) each of the adjacent large beam spots 44.

Referring to FIG. 4D, there is shown a laser beam spot configuration 48 including a first row 50 having overlapping relatively large beam spots 52 and a second row 54 (spaced-apart from first row 50) similarly having overlapping relatively large beam spots 56. As shown, the first beam spot row 50 and second beam spot row 54 have a gap therebetween extending along their entire linear dimension.

According to the invention, an intervening row 58 having overlapping relatively small beam spots 60 may be disposed between first and second large beam spot rows 50, 52 in order to cover the gap therebetween. The size and placement of small beam spots 60 is preferably chosen with a view towards eliminating the non-peened areas of the workpiece, namely, the gap between large beam spot rows 50, 52. Although the small beam spots 60 are overlapping with one another, any other arrangement may be used that is suited to the purpose of providing complete or desired laser peening surface coverage.

As discussed further herein, FIGS. 4C and 4D are generally illustrative of an interstitial feature of the invention in which normally smaller laser beam spots are used to provide not only a “fill-in” function (i.e., cover gaps in a large spot peening pattern), but also to provide a type of stress bridge between large beam spots. That is why, for example, small beam spot 46 (FIG. 4C) and small beam spot 60 (FIG. 4D) are suitably sized and located to extend into the large beam spots that are associated with the non-peened (or inadequately peened) gaps.

Meanwhile, FIGS. 4E-4G illustrate the laser beam spot “density” achievable using various combinations of large and/or small beam spots 61a and 61b, respectively, without laser spot intersection.

Referring now to FIG. 5, there is shown a schematic illustration of a workpiece portion 62 including an illustrative laser beam spot configuration 64 produced during a laser shock peening operation, according to one example of the invention. This diagram depicts a feature of the invention similar to that shown in FIG. 4A.

As shown, the beam spot configuration 64 includes a pattern of relatively large laser beam spots 66 applied during treatment processing to a surface of workpiece 62. The large laser beam spots 66 are disposed in a linear overlapping formation, although other formations may optionally be used. The beam spot configuration 64 also includes a pattern of relatively small laser beam spots 68 applied during treatment to the surface of workpiece 62 so as to lie (at least in part) within the interior of a respective surface area defined by large laser beam spot 66. In essence, the small laser beam spot pattern is superimposed upon the large laser beam spot pattern, although the order of application may optionally be reversed.

By virtue of the composite peening operation depicted in FIG. 5 (i.e., application of a large spot pattern and a small spot pattern), it becomes possible to achieve maximum compressive residual stress at an in-depth subsurface region (due to the large spot pattern) and maximum surface/near-surface stresses (due to the small spot pattern). In one form, the large spot would be circular with a diameter greater than 3 mm, while the small spot would similarly be circular with a diameter less than 1 mm. These numerical values are provided for illustrative purposes only, as it should be apparent that any suitable differential between the spot diameters and/or sizes may be employed. The advantage of different spot sizes is that it allows tailoring of the residual stress profile in the part to the required specifications.

According to various optional forms of the invention, the laser beam spot patterns may be applied as single or multiple layers. In a multi-layering or stacked application, several layers of large spots would be applied to the workpiece in order to further increase the depth of the residual stresses. Similarly, multiple layers of small spots would be applied to optimize the surface residual stresses. The use of multiple layers of small spots would also enable the in-depth (deeper) residual stress gradients to be relatively micro-adjustable and tailored in a more precise and smaller-scale fashion.

The sequence and number of layers can be implemented in any of various suitable forms. For example, a typical processing sequence would first apply the large beam spot layers and then apply the small beam spot layers. Optionally, the layers can be alternated or mixed in any suitable combination. For example, for purposes of reinforcement and to develop sufficient stress regions, it may be advisable to apply alternating sets or groups of large spot beam patterns and small spot beam patterns.

As indicated above, the order of spot application is flexible, although the small spot pattern would typically be applied last. For this purpose, two lasers may be used to implement the laser peening operation. For example, a relatively high-energy laser using a relatively low repetition rate firing mode (<2 Hz) would supply the large beam spots, while a relatively low-energy laser using a relatively high repetition rate firing mode (>2 Hz) would produce the small spots. It should be apparent that any parameter values used herein in connection with the laser peening operation are provided for illustrative purposes only and should not be considered in limitation of the invention, as other values may be used to practice the invention.

Optionally, a single laser could produce both the large and small spots. For this purpose, the laser peening apparatus could readily be programmed to adjust its laser beam output size, power level, and repetition rate, as known to those skilled in the art. For this case, one layer of spot sizes would be applied and then the other spot size layer would be applied.

Moreover, the invention may be practiced in connection with single-sided laser peening and double or dual-sided laser peening. In the case of dual-sided peening, when two layer beams are used, a conventional part manipulator can be used to maneuver the part to thereby expose each side in sequence to peening. A set of two laser beams can be used to simultaneously laser shock peen a part with large or small spot patterns. Two separate lasers or a single laser emitting two beams can be used to generate the two beams. It is further contemplated that each beam can have its own characteristic spot size (e.g., one large, one small; both the same size).

Referring now to FIG. 6, there is shown a cross-sectional view of a workpiece 70 subjected to laser shock peening, according to another example of the invention. The illustrated peening operation is applied to opposing sides of the workpiece and employs the superimposing pattern depicted in FIG. 5, namely, the application of a large laser beam spot followed by a small laser beam spot that lies within the surface area peened by the large spot.

As shown, workpiece 70 experiences a dual-sided laser peening operation that produces a relatively large laser shock peened surface 72 having a surface dimension 74, which may correspond to the diameter of a relatively large circular laser beam spot emission 80. Additionally, there is shown a relatively small laser shock peened surface 76 having a surface dimension 78, which may correspond to the diameter of a relatively small circular laser beam spot emission 82.

As shown, the laser beam emissions 80, 82 originate from different point sources, such as different laser devices, although a single laser may be employed using appropriate controls. The dual-sided laser peening operation produces a pair of opposing relatively large laser shock peened surfaces 72 and a pair of opposing relatively small laser shock peened surfaces 76. The two surfaces may be laser shock peened simultaneously or sequentially. As known, a layer or pattern of such peened surfaces may be produced at other locations of workpiece 70 in similar fashion. In a manner similar to that depicted in FIG. 5, laser shock peened surface 76 overlies or stacks upon laser shock peened surface 72, under conditions where the small-spot laser beam emission 82 is applied last.

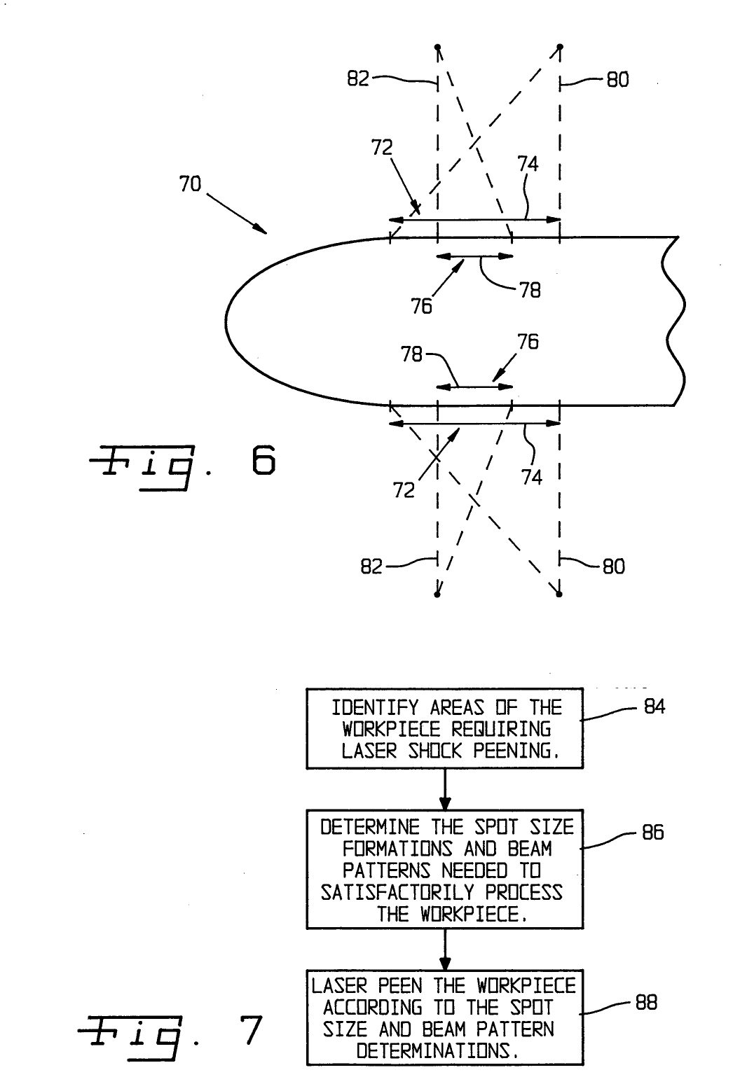

Referring now to FIG. 7, there is shown a flowchart describing a methodology for performing a laser shock processing treatment, according to another example of the invention. It may be determined that the geometry of the workpiece and unique service or operational conditions demand a precisely varying or modulated residual stress profile on the surface and in depth.

It may occur during production of a laser shock peened workpiece that various areas of the part require further peening. For example, mistakes or errors in formation of the laser beam pattern may yield a shock peened surface having areas left untreated that otherwise have been designated for processing.

Also, it may be determined that certain treated areas were not sufficiently peened. In this case, the invention includes a facility for determining the sufficiency and adequacy of the peening treatment received by the workpiece. For this purpose, the invention will include an evaluation procedure that examines processed parts to determine whether the treatment satisfies predetermined criteria defining the acceptability of parts. Any type of quality assurance (QA) program may be used for this purpose.

For example, one QA criterion may specify the substantial absence of any substantially non-peened areas on the workpiece. Another criterion may specify a minimally sufficient overlap among adjacent laser shock peening beam spots. A further criterion may involve a determination of whether a sufficient compressive residual stress distribution profile has been formed in the workpiece, such as at the surface and at certain critical interior locations.

Referring more specifically to FIG. 7, the indicated methodology includes a procedure for identifying and otherwise determining any areas of the workpiece that require laser shock peening, either in the first instance or as additional processing. (Step 84). Next, the appropriate beam spot sizes and beam patterns are specified that will effectuate adequate processing of the workpiece areas identified in step 84. (Step 86). The laser peening apparatus then processes the workpiece according to the operating protocol specified in step 86, namely, the selected beam spot sizes and beam patterns. (Step 88). Other peening variables will also be chosen, such as the firing order, the number and type of layers to be applied to the workpiece, the repetition rate, and power levels.

Referring now to FIG. 8, there is shown a schematic view of a workpiece section to illustrate the manner of peening a workpiece, according to the methodology set forth in FIG. 7.

As shown in FIG. 8, an illustrative peening operation forms a first and second row 90, 91 of spaced-apart laser beam spots 92. In one form as shown by FIG. 8, rows 90 and 91 are staggered or offset from one another. There is also provided a third row 93 of overlapping laser beam spots 94.

Referring to beam spot rows 90 and 91, the invention may be used to fill-in the untreated interstitial spaces or gaps that exist between same-row spots or adjacent-row spots. For example, a representative set of relatively small laser beam spots 95 may be placed in the gaps between adjacent spaced-apart laser beam spots 92 in row 90. Likewise, the gaps between adjacent rows may be filled with representative and illustrative laser beam spots of the type such as spots 96-1, 96-2, and 96-3.

Moreover, the invention may be used to provide additional processing to areas that have previously been treated. For example, a representative set of laser beam spots 97 may be used to reprocess the overlap region between adjacent overlapping beam spots 94 in row 93 in order to provide additional peening. The additional treatment may be in the specified processing plan or be needed, for example, if the overlap region is insufficient or for any other reason.

As shown in FIG. 8, relatively small spots can be used to moderate the compressive residual stress feed as desired or to fill in areas that have not been filled in during the application of the relatively large spot layer. The small spots would act as bridges to maintain the surface compressive residual stress field. The small spots would typically be applied at a higher repetition rate, and would thus decrease the time required to peen the surface. In addition, certain areas of the part can be treated with large spots only, small spots only, or a combination thereof.

In another form, the invention can facilitate the maintenance of a desired overall compressive stress profile by selectively inserting large spots or a layer of large spots to minimize distortions in a part.

As shown and described herein, the invention provides various features enabling both the surface compressive stresses and the depth of the stresses to be maximized when laser peening. Notable improvements are made to production pieces, especially when processing thin sections through double-sided peening, although single-sided peening is also possible. The use of small spots in double-sided peening of a thin section enables better control of the depth and magnitude of the compressive residual stresses.

Other features include the use of large and small spots to adjust the depth of the residual stresses produced during the laser peening of a part. The application of small spots may also be used as stress bridges between gaps in a large spot peening pattern. In one implementation, one laser may be used to supply the large spots, while the other laser supplies the small spots.

As discussed previously, the application of relatively large beam spots can maximize the depth of compressive residual stress in a part, while the use of relatively small beam spots can optimize the magnitude of the compressive stresses on the surface of the part. The invention generally avoids the need to modify the pulse width, and in particular the use of short laser pulses, as a basis for producing variations in the depth of magnitude of compressive stresses. The invention optimizes the compressive residual stress distribution profile within a part by controlling the shape of the stress field.

The invention may be employed in various applications. For example, the invention may be adapted for use in laser peening articles such as turbine airfoils, dovetail slots, screws, bolts, integrally-bladed rotors, and medical implants. Industrial uses include turbine blades, aerospace engines and structures, automotive parts, medical technology, and industrial equipment.

As discussed previously, the conventional problem of using relatively short pulse widths to achieve variations in stress penetration depth is overcome by the invention, which relies instead upon adjustments to laser beam spot size while maintaining a relatively longer and more stable pulse width. Although the compressive residual stresses produced by the small spots are not as deep as in the large spot treatment, the surface residual stresses may be made higher.

Another problem that small spots can overcome is the centerline cracking that can occur during simultaneously double-sided laser peening of thin sections. The large spots currently used in laser peening produce a strong tensile shock wave interaction at the center of the thin section. This effect is the result of the compression shock waves traveling through the thin section and reflecting as tensile shock waves from the opposite surface. The impedance mismatch at the opposite surface causes each shock wave to be reflected as a tensile wave. The additive effect of the tensile stresses when the reflected waves from both sides meet at the middle of the section thickness can result in cracking along the section mid-plane.

By comparison, small spots do not have the penetration depth of large spots. This difference is due to release waves traveling into the shock wave from the circumference of the spot, thus decreasing the peak pressure of the shockwave from a small spot more rapidly as it travels into the material. For spot diameters less than 1 to 2 mm, as the spot size decreases, this effect occurs at a shallower depth. By limiting the high peak pressure to the near-surface zone in thin sections by using a comparatively small diameter spot size, it is possible to avoid a strong interaction with the preexisting residual stress on the opposite surface and the strong tensile interaction of the high pressure shock waves at mid-thickness.

The result of these characteristics is that high peak pressure shock waves can be applied when using small spots in order to produce high surface compressive stresses without increasing mid-thickness cracking or reduction of the residual stress in the opposite surface. As a result, strong tensile shock wave interaction is avoided.

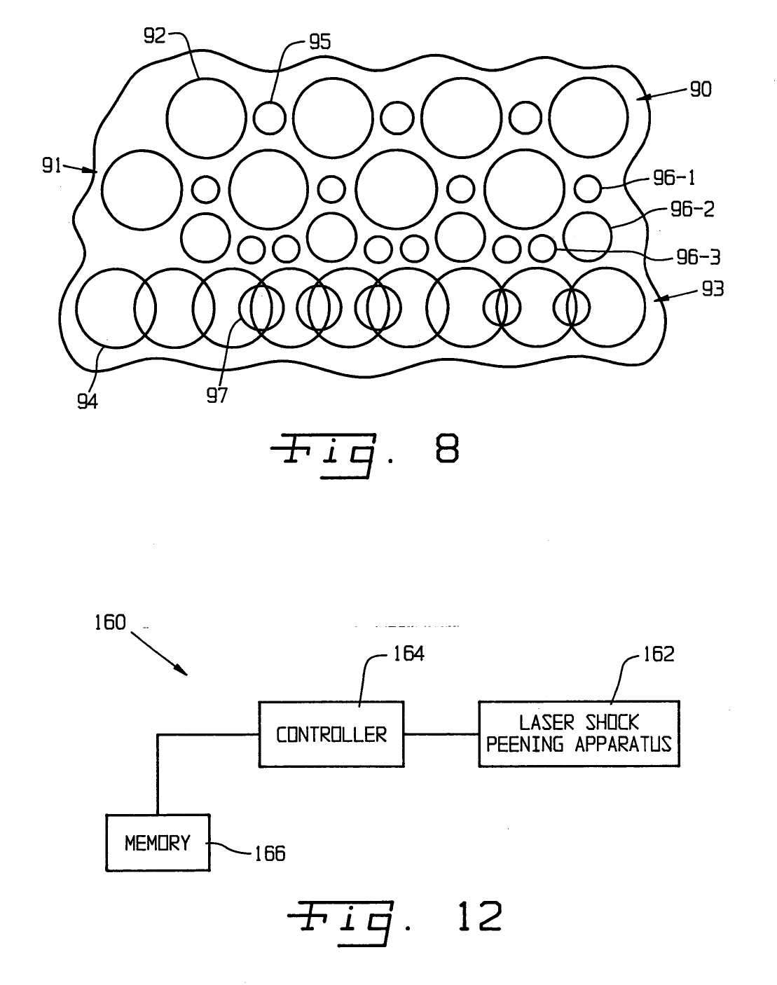

Referring now to FIG. 9, there is shown an illustrative laser shock processing (LSP) environment 100 that is representative of the type of configuration capable of being used in connection with the present invention.

The illustrated LSP environment 100 includes a target chamber 102 in which the laser shock process takes place. The target chamber 102 includes an opening 104 to receive a laser beam 106 generated by laser 108, a source of coherent energy. Laser 108, by way of example, may be a commercially available high power pulse laser system capable of delivering more than approximately 40 joules in 5 to 100 nanoseconds. The laser pulse length and focus of the laser beam may be selectively adjusted.

A representative workpiece 110 is held in position within target chamber 102 by means of a suitable positioning mechanism 112. Positioning mechanism 112 may be of the type that includes a robotically controlled arm or other apparatus to precisely position workpiece 110 relative to the operational elements of laser shock peening system 100.

In one illustrative configuration, LSP environment 100 includes a material applicator 114 for applying an energy absorbing material onto workpiece 110 to create a coated portion, i.e., an opaque overlay. Material applicator 114 may be provided in any suitable form such as a solenoid-operated painting station or other construction, e.g., a jet spray or aerosol unit to provide a small coated area onto workpiece 110.

The material utilized by material applicator 114 is preferably an energy absorbing material, typically a black, water-based paint such as 1000 F AQUATEMP (TM) from Zynolite Product Company of Carson, Calif. Another opaque coating that may be utilized includes ANTI-BOND, a water soluble gum solution including graphite and glycerol from Metco Company, a Division of Perkin-Elmer of Westbury, N.Y. Alternatively, other types of suitable opaque coatings may be used.

LSP environment 100 further includes a transparent overlay applicator 116 that applies a fluid or liquid transparent overlay to workpiece 110 over the portion coated by material applicator 114. The transparent overlay material should be substantially transparent to the incident radiation, with water being the preferred overlay material.

As shown, material applicator 114 and transparent overlay applicator 116 are shown directly located within target chamber 102. However, this is merely illustrative, since in a production environment, only the necessary operative portions need be accessible to the processing environment of target chamber 102, such as the portion through which the materials actually flow, e.g., a fluid dispenser head. The supply tanks for the transparent overlay materials and other energy absorbing materials may be located outside of target chamber 102 or any other suitable location.

A control unit such as controller 118 is operatively associated with the combination of functional elements including material applicator 114, transparent overlay material applicator 116, laser 108, and positioning mechanism 112. In particular, controller 118 is connected to laser 108, positioning mechanism 112, material applicator 114, and transparent overlay material applicator 116 via control lines 120, 122, 124, and 126, respectively. Controller 118 controls the operation and timing of each of the applicators 114 and 116, laser 108, and selective operation of positioning mechanism 112 to ensure proper sequence and timing of system 100. In one configuration, controller 118 may be a programmed personal computer or microprocessor. In another configuration the entire processing operation is automated.

In a typical operation, workpiece 110 is located within targeting chamber 102 by positioning mechanism 112. Controller 118, in one illustrative operating sequence, activates material applicator 114 to apply a laser energy absorbing coating such as a water-based black paint onto a particular location of workpiece 110 intended for laser shock processing. Controller 118 next directs transparent overlay material applicator 116 to apply a transparent overlay to the previously coated portion of workpiece 110.

At this point, laser 108 is directed by controller 118 to fire a laser beam 104 that impacts the coated portion. The time between applying the transparent water overlay and the step of directing the laser energy pulse may be on the order of 0.1 to 3.0 seconds, for example. By directing this pulse of coherent energy to the coated portion, a shock wave is created at the workpiece surface. As the plasma expands from the impact area, it creates a compressional shock wave passing against and through workpiece 110 that imparts regions of compressive residual stresses within workpiece 110.

The above-described process or portions of the process may be interactively repeated to shock process the desired surface area of workpiece 110. Depending upon the energy levels and the amount of laser shock peening desired on workpiece 110, controller 118 may instruct positioning mechanism 112 to re-position or re-index workpiece 110 or laser 108 to a new location or orientation. This mobility of workpiece 110 and/or laser 108 (by means not shown) enables further laser shock peening operations to be performed that may process the same or different portions of the workpiece, for example, the formation of a matrix of laser beam spots overlapping the previously peened area. Each additional operating sequence typically requires its own set of coatings to be applied to the workpiece and an accompanying sequence of laser firings from laser 108. Any suitable means may be provided to change the relative spatial relationship (e.g., orientation and distance) between the laser and workpiece.

The present invention may be practiced in connection with any suitable workpiece or object. A workpiece may include any solid body, article, or other suitable structure that is amenable to or otherwise capable of being treated by laser shock processing. The workpiece may represent a constituent piece forming part of an in-production assembly, a final production article, or any other desired part. Accordingly, the laser shock processing treatment may be applied at any stage of production, i.e., a pre- or post-manufacturing step or other intervening time.

In certain industrial applications, the present invention finds significant use in processing the airfoils of an integrally bladed rotor, most notably in the region proximate the leading and trailing edges where operating and design conditions can lead to high-cycle failures, posing serious problems affecting the performance and durability of the engine.

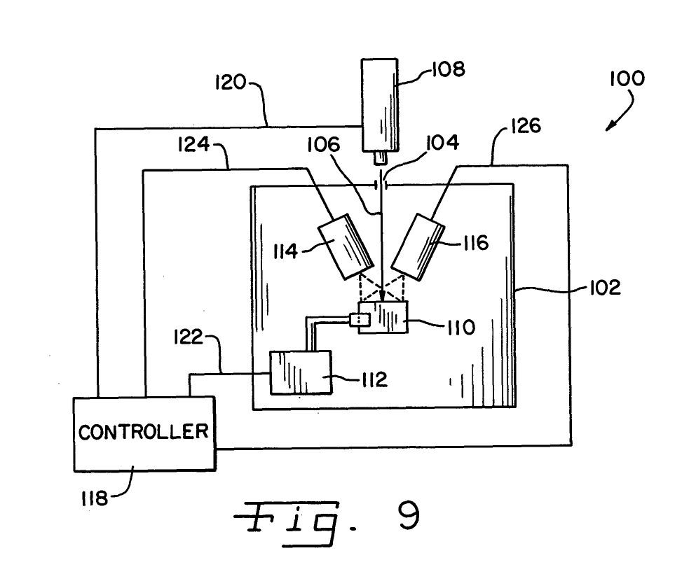

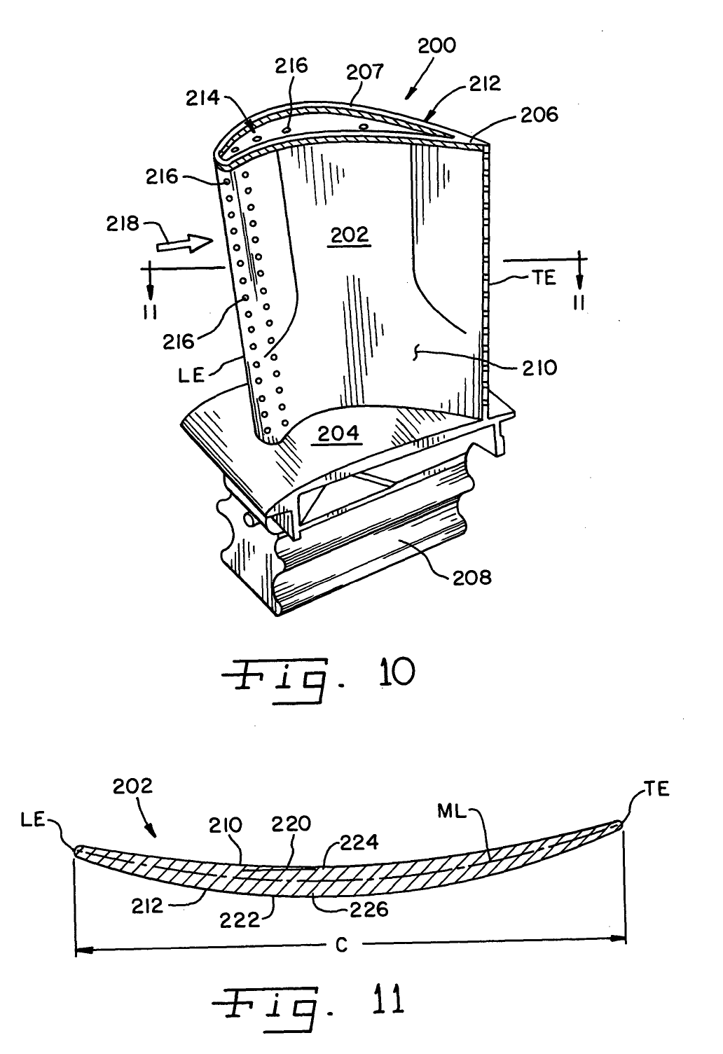

Referring briefly to FIG. 10, there is shown a perspective view of an illustrative aircraft gas turbine engine blade 200 with which the present invention can be practiced. FIG. 11 is a planar cross-sectional schematic view of the airfoil section of engine blade 200, taken along lines 15-15 in FIG. 10.

The illustrated aircraft engine blade 200 includes an airfoil 202 extending radially outward from a blade platform 204 to a blade tip 206. The engine blade 200 includes a root section 208 for attachment to a rotor. Alternately, some blades are forged or cast integrally with a rotor, i.e., a blisk or integrated rotor and disk assembly. Airfoil 202 includes a leading edge LE and a trailing edge TE.

Referring further to FIG. 11, a chord C of airfoil 202 is the line between the leading edge LE and the trailing edge TE at each cross-section of the engine blade. Airfoil 202 extends in a chordwise direction between the leading edge LE and trailing edge TE. A pressure side 210 of airfoil 202 faces in the general direction of rotation, while a suction side 212 is on the other side of airfoil 202. A mean-line ML is generally disposed midway between the two faces (i.e., pressure and suction sides) in the chordwise direction.

The blade tip 206 extends along the tip of airfoil 202 from the leading edge LE to the trailing edge TE. A radially extending wall 207 optionally circumscribes airfoil 202 at the outer edge of blade tip 206 to form an open cavity 214 within the wall. In a configuration where airfoil 202 is hollow, ports 216 are located through airfoil 202 in communication with cavity 214. Although ports 216 are shown on pressure surface 202 and leading edge LE, ports 216 may be located in other locations, surfaces and edges of airfoil 202. The airfoil section depicted by FIG. 11 is from a solid body construction of airfoil 202.

Arrows 218 generally depict the orientation of a potential laser peening operation against blade 200. Of course, other orientations and positions of laser peening may be applied to blade 200. For example, referring to FIG. 11, pressure side 210 and suction side 212 may be laser shock peened to produce respective laser shock peened surfaces 220 and 222 having respective regions 224 and 226 with deep compressive residual stresses imparted by laser shock peening extending into airfoil 202 from the laser shock peened surfaces.

Referring to FIG. 12, there is shown a simplified block diagram illustration of a system for use in practicing the present invention. In its most elemental form, the system 160 includes a laser shock peening apparatus 162 and a controller 164 for selectively controlling the operation of laser shock peening apparatus 162 in conjunction with laser shock processing a specified object.

In a preferred form, controller 164 is selectively configurable to enable any type of laser shock operating sequence to be performed. For example, when controller 164 has a computer or microprocessor-based implementation, a suitable program code of instructions may be loaded into memory 166 and transferred to controller 164 for execution. The program code would fully define the series of control commands and instructions needed to execute, govern, and manage a corresponding laser shock processing operation as carried out by laser shock peening apparatus 162.

A suitable user input device (not shown) may be optionally added to enable a user to input or change various operating parameters.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A laser shock processing method for use with a workpiece, said method comprising the steps of:
forming on said workpiece at least one laser beam spot having a first spot size; and
forming on said workpiece at least one laser beam spot having a second spot size different than the first spot size.

2. The method as recited in claim 1, wherein the first spot size being larger than the second spot size.

3. The method as recited in claim 2, wherein formation of the at least one laser beam spot having the first spot size occurring prior to formation of the at least one laser beam spot having the second spot size.

4. The method as recited in claim 1, wherein formation of the at least one laser beam spot having the first spot size further comprises the step of:
forming on said workpiece in stacking relationship a first plurality of laser shock peened surface patterns each having a plurality of laser shock peened surfaces.

5. The method as recited in claim 4, wherein formation of the at least one laser beam spot having the second spot size further comprises the step of:
forming on said workpiece in stacking relationship a second plurality of laser shock peened surface patterns each having a plurality of laser shock peened surfaces.

6. The method as recited in claim 5, wherein the first plurality of laser shock peened surface patterns and the second plurality of laser shock peened surface patterns are formed on the same general portion of said workpiece.

7. The method as recited in claim 5, wherein the first plurality of laser shock peened surface patterns and the second plurality of laser shock peened surface patterns are formed in a general interleaving sequence.

8. A system, comprising:
a laser shock peening apparatus; and
a controller to selectively control operation of said laser shock peening apparatus;
said controller being configured to direct said laser shock peening apparatus to laser shock peen a workpiece to form on said workpiece at least one laser beam spot having a first spot size and at least one laser beam spot having a second spot size different than the first spot size.

9. An article, comprising:
a plurality of laser shock peened surfaces; and
a plurality of regions each having compressive residual stresses imparted by laser shock peening, each region extending into said article from a respective laser shock peened surface;
said plurality of regions including at least one region having a first compressive residual stress distribution profile and at least one region having a second compressive residual stress distribution profile different than the first compressive residual stress distribution profile.

10. A method for use with a workpiece, said method comprising the steps of:
determining a stress distribution profile for possible development within said workpiece;
determining a laser shock processing treatment for possible use with said workpiece sufficient to facilitate and/or effectuate development of the determined stress distribution profile;
the laser shock processing treatment determination including the step of selecting at least one laser beam spot size; and
subjecting the workpiece to the laser shock processing treatment.

11. The method as recited in claim 10, wherein the laser beam spot size selection further comprises the step of:
selecting a plurality of different laser beam spot sizes.

12. A method for use in treating a laser shock peened workpiece, said method comprising the steps of:
identifying areas of said laser shock peened workpiece failing to satisfy a predetermined processing criteria; and
laser shock peening at least one of the identified areas.

13. The method as recited in claim 12, wherein the predetermined processing criteria includes a criterion specifying the substantial absence of any substantially non-peened areas.

14. The method as recited in claim 12, wherein the predetermined processing criteria includes a criterion specifying a minimally sufficient overlap among adjacent laser shock peening beam spots.

15. The method as recited in claim 12, wherein the laser shock peening step further comprises the step of:
forming on said workpiece at least one laser beam spot having a size relatively smaller than a laser beam spot used in connection with production of the laser shock peened workpiece.
